(19) United States
(12) Patent Application Publication
(10) Pub. No.: US 2008/0012811 A1
(43) Pub. Date: Jan. 17, 2008

(54) Display device and driving method thereof

(75) Inventors: Si-Duk Sung, Seoul (KR); Chun-Seok Ko, Hwaseong-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/827,913

(22) Filed: Jul. 12, 2007

(30) Foreign Application Priority Data
Jul. 12, 2006 (KR) 10-2006-0065285

(51) Int. Cl. G09G 3/36

(52) U.S. Cl. 345/89

(57) ABSTRACT

A display device includes a plurality of pixels in a matrix form, with each pixel having a switching transistor and a driving transistor, a plurality of data lines coupled with the switching transistors and providing data voltages, a plurality of driving voltage lines providing driving voltages to the drive transistors, a gray voltage generator generating compensated reference gray voltages based on a voltage-drop of the driving voltage, and a data driver providing input image data to the data lines as data voltages based on the compensated reference gray voltage.

### CROSS REFERENCE TO RELATED APPLICATION

This application claims priority to and the benefit of Korean Patent Application No. 10-2006-0065285 filed in the Korean Intellectual Property Office on Jul. 12, 2006. This application is incorporated herein by reference in its entirety.

### BACKGROUND OF THE INVENTION

(a) Field of the Invention

This invention relates to a display device and its driving method and, more specifically for example, to an organic light emitting device having an anode, a cathode, and a layer containing an organic compound that emits light upon application of an electric field. This invention also relates to an organic light emitting display device manufactured using the device and the method thereof.

(b) Description of the Related Art

In response to the demand for lighter and thinner display devices, cathode ray tubes (CRTs) are being replaced with liquid crystal displays (LCDs). An LCD, however, typically requires an additional backlight device for emitting light and is limited in terms of response speed and viewing angle for the display device.

In order to overcome such problems, an organic light emitting diode (OLED) display device is suggested as an alternative. This OLED device comprises an anode, a cathode, and a radiation (emission) layer containing an organic compound which emits light upon application of an electric field. When a voltage is applied to the two electrodes (anode and cathode), holes from the anode and electrons from the cathode are injected into the radiation layer. Once the electrons and the holes meet, exitons are formed and generate some energy as light to illuminate the OLED display.

The organic light emitting display device is a self-emission type of display that does not require a separate light source and therefore may be advantageous in terms of power consumption and may provide good response speed, viewing angle, and contrast ratio. The radiation layer, which is a compound layer, is made of organic material having its own primary colors such as red, green, and blue, with a desired image displayed by the spatial sum of colored light of the primary colors emanated by the radiation layer.

As the size of the OLED display device increases, the power consumption increases and the current required for expressing the same brightness increases. As the size of the OLED display device is expanded, a voltage-drop occurs on the display panel because an operational voltage decreases as a voltage receiving portion is positioned farther from a voltage source. Therefore, the quality of the display image deteriorates, such as in terms of luminance and uniformity, and crosstalk may be a problem.

As a result there is a need for an OLED display device for displaying a more uniform image on screen without degrading an aperture ratio.

### SUMMARY OF THE INVENTION

An exemplary embodiment of the present invention provides a display device including: a plurality of pixels arranged in a matrix form and including switching transistors and driving transistors; a plurality of data lines connected with the switching transistors and transferring a data voltage; a plurality of driving voltage lines for transferring a driving voltage to the driving transistors; a gray voltage generator for generating a reference gray voltage reflecting an amount of voltage drop of the driving voltage; and a data driver for converting an input image signal into the data voltage based on the reference gray voltage and applying the converted data voltage to the data lines.

The reference gray voltage may have a voltage value that changes with time. The reference gray voltage may change at least every two pixel rows. The reference gray voltage may increase toward the lower pixel rows. The changed amount of the reference gray voltage may be uniform.

The reference gray voltage may change at every four pixel rows. The changed amount of the reference gray voltage of the last pixel row may be substantially the same as the total amount of the voltage drop of the driving voltages. The gray voltage generator may be driven in a digital manner.

Another embodiment of the present invention provides a display device including: a plurality of pixels arranged in a matrix form; scanning lines for transferring scanning signals to the pixels; a plurality of data lines for transferring a data voltage to the pixels; and a data driver for converting an input image signal with a gray level into the data voltage and applying the data voltage to the data lines.

A value of a data voltage corresponding to the same gray level can be different according to positions of pixels. The data driver may select a gray voltage corresponding to the gray level of the input image signal among a plurality of gray voltages as a data voltage, and the voltage value of the gray voltage can differ depending on the positions of the pixels.

Yet another embodiment of the present invention provides a method for driving a display device including a plurality of pixels arranged in a matrix form and driving voltage lines connected with the pixels, including: measuring a voltage difference between both ends of the driving voltage line; generating a correction value of a reference gray voltage from the voltage difference and generating the reference gray voltage reflecting the correction value; and dividing the reference gray voltage and selecting a gray voltage according to gray level information.

The correction value may change at least every two pixel rows. The correction value may increase toward lower pixel rows. An amount of change of the correction value may be uniform.

The correction value may change at least every four pixel rows. A correction value of the last pixel row may be substantially the same as the total amount of the voltage drop of the driving voltages.

### BRIEF DESCRIPTION OF THE DRAWINGS

The features and advantages of embodiments of the present invention are apparent in reference to the detailed description the following drawings.

FIG. 1 illustrates a block diagram of an organic light emitting display device in accordance with an embodiment of the present invention.

FIG. 2 illustrates an equivalent circuit for one pixel of the organic light emitting display device shown in FIG. 1 in accordance with an embodiment of the present invention.

FIG. 3 illustrates a graph showing reference gray voltages and driving voltage drops as a function of pixel rows in accordance with an embodiment of the present invention.

FIG. 4 shows a gray voltage generator in accordance with an embodiment of the present invention.

FIG. 5 shows a waveform of a driving signal of the gray voltage generator in FIG. 4 in accordance with an embodiment of the present invention.

FIG. 6 shows a table including data of the gray voltage generator in FIG. 4 in accordance with an embodiment of the present invention.

FIG. 7 shows a coordinate graph between gammas and gray levels in accordance with an embodiment of the present invention.

FIG. 8 shows one example of reference gray voltages to the gammas in FIG. 7 in accordance with an embodiment of the present invention.

FIG. 9 shows another example of reference gray voltages to the gammas in FIG. 7 in accordance with an embodiment of the present invention.

FIG. 10 shows one example of luminance measure points on display panel in accordance with an embodiment of the present invention.

FIG. 11 shows a table including luminance for gammas at each point in FIG. 10 based on gammas of FIG. 8 and FIG. 9 in accordance with an embodiment of the present invention.

FIG. 12 is a bar graph of FIG. 11 in accordance with an embodiment of the present invention.

FIG. 13 illustrates another example of luminance measure points on display panel in accordance with an embodiment of the present invention.

FIG. 14 shows a table including luminance for gammas at each point in FIG. 13 based on gammas of FIG. 8 and FIG. 9 in accordance with an embodiment of the present invention.

### DETAILED DESCRIPTION OF THE EMBODIMENTS

The present invention will be described more fully hereinafter with reference to the accompanying drawings, in which preferred embodiments of the invention are shown. As those skilled in the art would realize, the described embodiments may be modified in various different ways, all without departing from the spirit or scope of the present invention.

In the drawings, it will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on” another element, there are no intervening elements present.

A display device and its driving method according to an exemplary embodiment of the present invention will be described in detail with reference to the accompanying drawings.

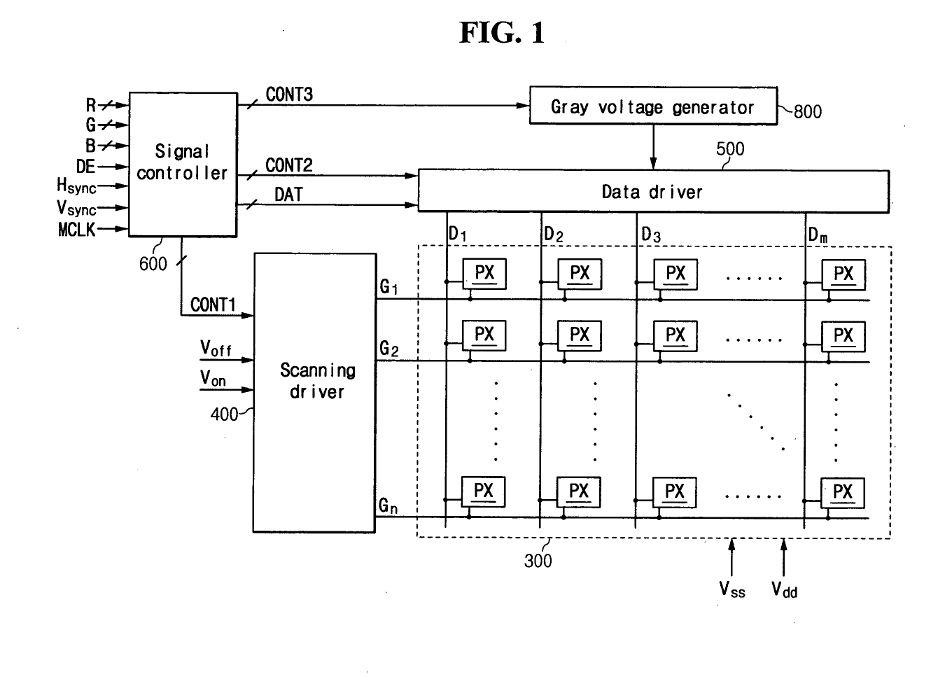

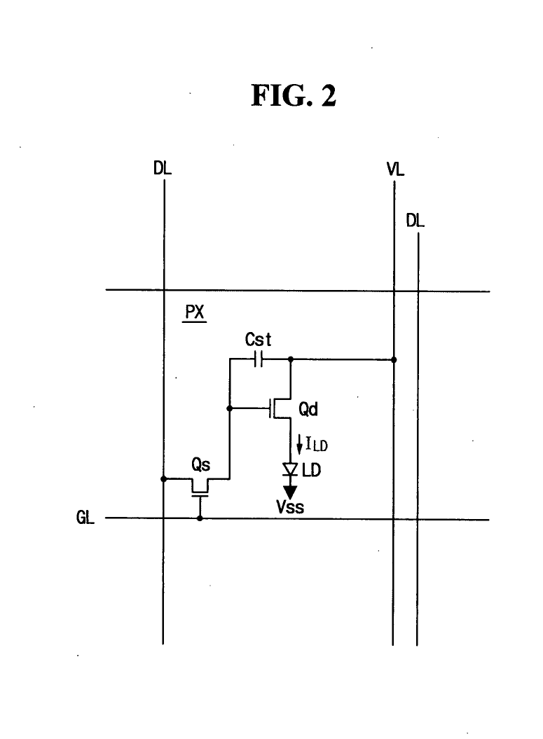

FIG. 1 is a block diagram of an organic light emitting display device according to an embodiment of the present invention and FIG. 2 is an equivalent circuit for one pixel of the display device according to an embodiment of the present invention.

Referring to FIG. 1 and FIG. 2, an organic light emitting diode (OLED) display device includes a display panel 300, a scanning (gate) driver 400, a data driver 500, a gray voltage generator 800, and a signal controller 600 for controlling all of them.

The display panel 300 includes pixels PX that are coupled to signal lines G1-Gn, D1-Dm in a matrix form. The signal lines includes gate (scanning) lines G1-Gn and GL for transferring scanning signals, data lines D1-Dm and DL for transferring data voltages, and drive voltage lines VL for transferring a driving voltage Vdd. The gate lines G1-Gn, GL run parallel with each other in a row direction. The data lines D-Dm, DL run parallel with driving voltage lines VL in a column direction.

As shown in FIG. 2, the driving voltage line VL runs parallel with the data line DL, and receives a driving voltage Vdd from the top or bottom of the display panel 300. The driving voltage line VL may run parallel with the gate line GL.

Each pixel PX of the OLED display device includes an organic light emitting element LD, a driving transistor Qd, a storage capacitor Cst and a switching transistor Qs.

The switching transistor Qs includes a control terminal, an input terminal, and an output terminal, with the control terminal connected to the gate line GL, the input terminal connected to the data line DL, and the output terminal connected to the driving transistor Qd. Also, the switching transistor Qs allows for a data signal to be transferred from the data line DL in response to a gate signal on the gate line GL.

The driving transistor Qd includes a control terminal, an input terminal, and an output terminal, with the control terminal connected to the switching transistor Qs, the input terminal connected to the driving voltage line VL, and the output terminal connected to the organic light emitting element (OLED) LD. Also, the driving transistor Qd produces an output current ILD. The output current ILD varies according to the voltage difference between the control terminal and the output terminal of the driving transistor Qd.

The storage capacitor Cst is connected between the control terminal and input terminal of the driving transistor Qd. This storage capacitor Cst charges based on a data signal which is applied to the control terminal of the driving transistor Qd, and maintains its level even after the switching transistor Qs is turned off.

The organic light emitting element LD is an organic light emitting diode OLED, and comprises a cathode coupled with common voltage Vss and an anode coupled with the output terminal of the driving transistor Qd. The organic light emitting element LD emits light in proportion to the output current ILD of the driving transistor Qd to display an image.

The switching transistor Qs and the driving transistor Qd are n-type field effect transistors (FETs) made of amorphous silicon or polycrystalline-silicon. At least one of them may be a p-type FET. It should be noted that the connection relationship of the transistors Qs and Qd, the capacitor Cst, and the LD may vary according to the particular application without departing from the principles of embodiments of the present invention.

In FIG. 1, the gray voltage generator 800 generates a plurality of reference gray voltages (for the desired luminance) for each pixel PX. The number of reference gray voltages is fewer than the number of whole gray voltage levels, and their voltage values may change with time and reflect an amount of voltage drop of the driving voltage Vdd. For example, the reference gray voltages may decrease due to resistance and parasitic capacitance on the data lines. The reference gray voltages may also decrease with the passage of time. The variation of the reference gray voltage is referred to as a voltage drop (e.g., referred to herein as a voltage-drop of the driving voltage). Wherein, the reference gray voltage or gray voltage may be represented by a gray level.

The gate driver 400 is coupled with gate lines G1-Gn and provides gate signals to the gate lines G1-Gn, in which the gate signals comprise a high voltage Von by which the switching transistor Qs is turned on and a low voltage Voff by which the switching transistor Qs is turned off.

The data driver 500 which is coupled with data lines D1-Dm receives a plurality of reference gray voltages from the gray voltage generator 800 and generates data voltages. The data voltages which are produced based on the reference gray voltages are transferred to the data lines D1-Dm, in which each reference gray voltage data voltage is divided into several voltages which are the data voltages.

Signal controller 600 controls gate driver 400, data driver 500 and gray voltage generator 800. The drivers 400, 500, 600, and 800 may be formed on the display panel 300 together with the signals G1-Gn, D1-Dm and thin film transistors Q.

Alternatively, the drivers 400, 500, 600, and 800 may be formed on the display panel 300 with the use of one chip, with the use of a tape carrier package TCP in the form of flexible printed circuit film, or mounted on a separate printed circuit board. As an additional alternative, drivers 400, 500, 600, and 800 may be formed in one or more chips within or outside panel 300.

The operation and method of this organic light emitting display device will now be explained in detail.

The signal controller 600 receives an input image signal R, G, B and its input control signal for controlling display of the image signal from an external graphics controller (not shown). The input image signal R, G, B includes luminance information of each pixel, in which the luminance may be represented by the number of gray levels, for example 1024(=2¹⁰), 256(=2⁸), or 64(=2⁶) gray levels. For example, the input control signal may include a vertical synchronization signal Vsync, a horizontal synchronization signal Hsync, a main clock signal MCLK, and a data enable signal DE.

The signal controller 600 generates an output image signal DAT, a gate (scanning) control signal CONT1, a data control signal CONT2 and a gray voltage control signal CONT3 in response to the input signals R, G, B and an input control signal in order to apply them to the display panel 300. The signal controller 600 provides the gate control signal CONT1 to the gate driver 400, and the gray voltage control signal CONT3 to the gray voltage generator 800. At the same time, both the data control signal CONT2 and the output image signal DAT are provided to the data driver 500.

The gate control signal CONT1 includes an injection (scanning) start signal STV and at least one clock, in which the injection start signal STV indicates that injection of high voltage Von starts and the clock signal controls the output period of high voltage Von. The gate control signal CONT1 may include an output enable signal OE which limits the duration time of the high voltage Von.

The data control signal CONT2 includes a horizontal synchronization start signal STH which indicates the start of the transfer of output image signal DAT to one row of pixels PX. The data control signal CONT2 may include a data clock signal HCLK and a load signal LOAD which indicates that analog data voltage is to be transferred to the data lines D1-Dm.

The gray voltage control signal CONT3 includes gamma data (GAMMA) for generating reference contrast (gray) voltages, in which the gamma data GAMMA are digital signals. The gray voltage generator 800 generates reference gray voltages for data driver 500 in response to the gamma data GAMMA received from the signal controller 600. The gamma data changes with time, as does the reference gray voltage values.

The data driver 500 generates gray voltages for all gray levels by dividing the reference gray voltages. In response to the data control signal CONT2 from the signal controller 600, the data driver 500 receives an output image data DAT, with respect to one row of pixels PX, and selects gray voltages corresponding to the output image data DAT. Thereafter, the output image data DAT, which are digital data voltages, are changed into analog data voltages, and provided to the corresponding data lines D1-Dm by data driver 500.

The gate driver 400, which is also called an injection driver or scanning driver, provides an injection signal having a high voltage Von to gate lines G1-Gn in response to the gate control signal CONT1 of signal controller 600. Then, switching transistors Qs coupled with the gate lines G1-Gn are turned on and therefore data voltages on the data lines D1-Dm are provided to the terminals of driving transistors Qd in each pixel.

The data voltages provided to the driving transistor Qd are charged in storage capacitors Cst. Though the switching transistors Qs are turned off, the charged data voltages in the storage capacitors Cst can be preserved. Owing to the data voltages preserved in the storage capacitors Cst, the driving transistors Qd generate output current ILD based on the magnitude of the data voltages. Accordingly, the organic light emitting element (OLED) LD emits light in proportion to the magnitude of output current ILD so that each pixel PX can display its image.

After one horizontal cycle (1H) which is one cycle of the horizontal synchronization signal Hsync and the data enable signal DE is finished, the data driver 500 and the gate driver 400 repeat their operation on the next pixel row. By this method, all gate lines G1-Gn sequentially receive the gate signal during one frame period and thus data are applied to all pixels PX. When one frame finishes, the next frame starts, with the same operation repeatedly performed.

The gray voltage generator according to an exemplary embodiment of the present invention will now be described in detail.

Referring to FIG. 2, at points progressively further away from the portion to which the driving voltage Vdd is applied, a voltage drop in the driving voltage line VL occurs due to resistance. For example, the driving voltage line VL extends parallel with the data line DL and receives a driving voltage Vdd from the top of the panel 300. Namely, the driving voltage Vdd provided to the pixel which is formed close to the top of the panel is greater than that of the pixel which is formed far from the top of the panel 300. Hence, the current provided to the pixels may be different according to the pixel row locations and thus luminance of each pixel may differ.

If each pixel receives a different driving voltage Vdd, which is referred to as a voltage drop, luminance of each pixel may be compensated by increasing the voltage applied to the data line DL by as much as the corresponding voltage drop.

As explained above, the data driver 500 generates data voltage by dividing the reference gray voltage from the gray voltage generator 800. By providing a compensation voltage in addition to the reference gray voltage, the voltage-drop along the pixel column is eliminated. The compensation voltage may be as much as the voltage-drop value. The voltage-drop value of each pixel row may be measured by direct measurement of the driving voltage Vdd which is provided to each pixel row. So, the compensation voltage for the voltage-drop may have a different value for every pixel row. Alternatively, the voltage-drop value of each pixel row may be determined from the voltage difference between the driving voltage Vdd of the first pixel row and the last pixel row, in which the voltage difference between the first pixel row and the last pixel row is divided by the number of pixel rows. So, an average voltage-drop value with respect to each pixel row can be calculated.

When the amount of voltage drop of the driving voltage Vdd is reflected on the reference gray voltage, it can be reflected on every pixel row or every multiple (m) of pixel rows. For example, when the compensation voltage for the voltage-drop value is applied to the reference gray voltage every m pixel rows, where the number of whole pixel rows is equal to “n” (where m is an integer having 1≦m≦n), a voltage increase (Vc) may be determined by the following equation.

Vc=ΔV×m/n [Equation 1]

Here, ΔV is a driving voltage difference between the first pixel row and the last pixel row.

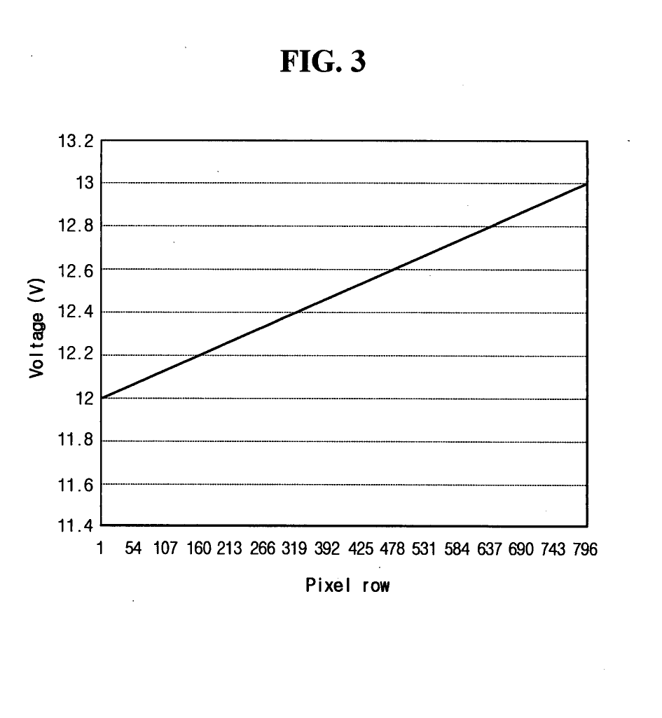

FIG. 3 illustrates a graph showing a compensated reference gray voltage for 800 pixel rows in accordance with an embodiment of the present invention. For example, while the reference gray voltage of the first pixel row is 12 V, the reference gray voltage of the 796^{th} pixel row, which is far from the first pixel row, is 13V. For this example, the voltage difference of the reference gray voltages between the first and last pixel rows is about 1V.

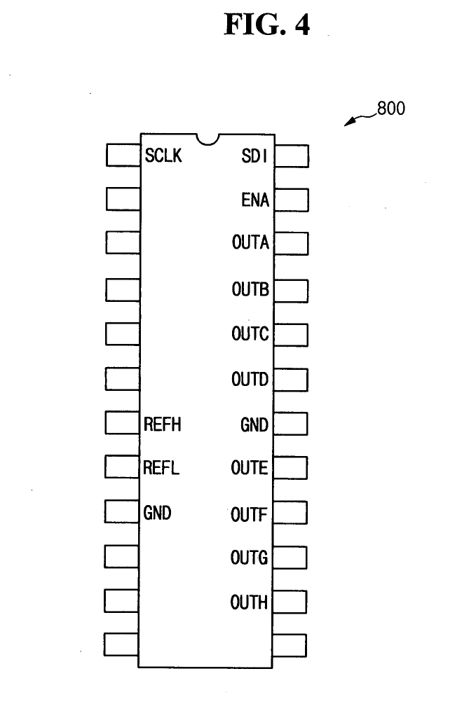

The structure and operation of the gray voltage generator of the display device in accordance with an embodiment of the present invention will now be described in detail with reference to FIG. 4 to FIG. 7.

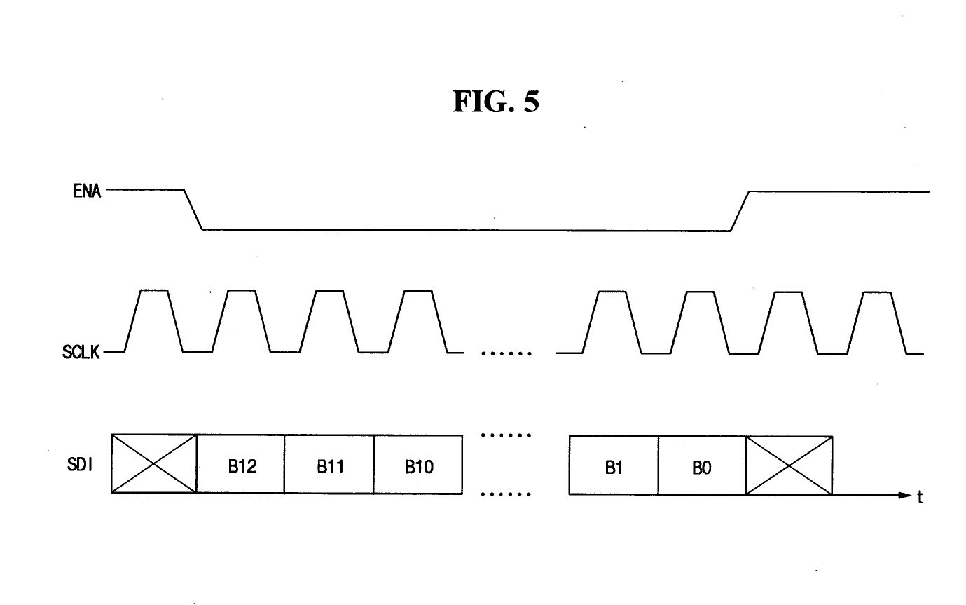

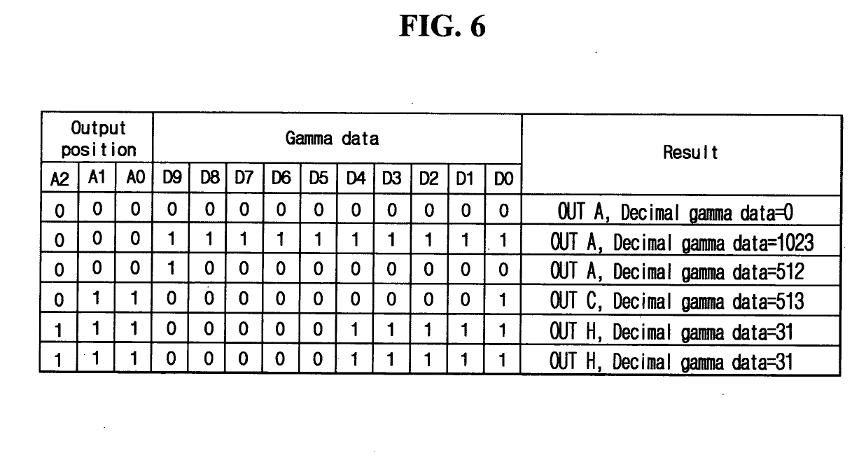

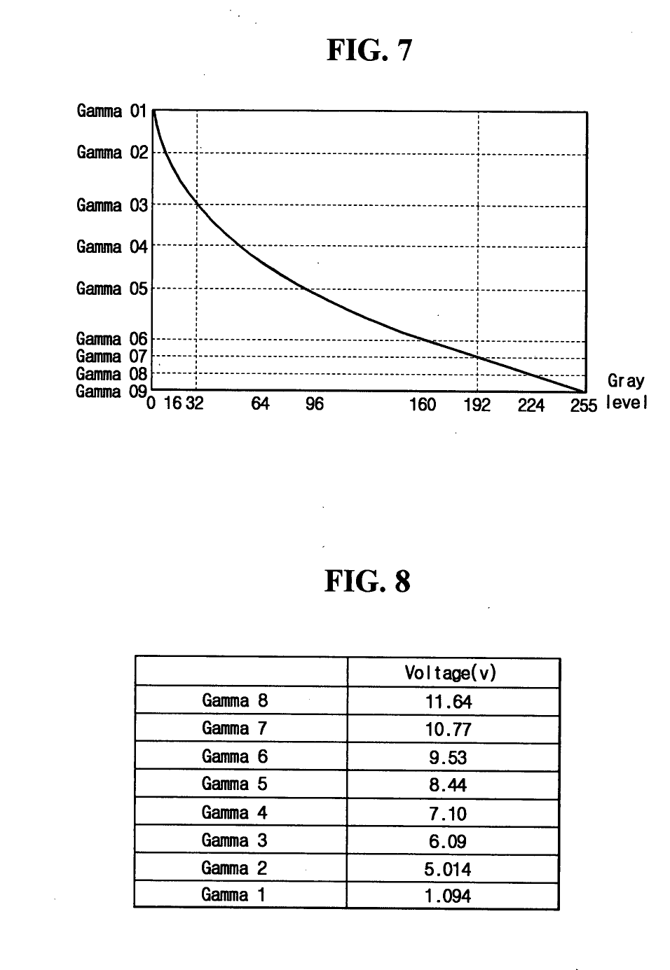

FIG. 4 shows a gray voltage generator for the display device according to an embodiment of the present invention and FIG. 5 shows a waveform of a driving signal of the gray voltage generator in FIG. 4. FIG. 6 shows a table including data of the gray voltage generator in FIG. 4 and FIG. 7 shows a coordinate graph between gammas and gray levels.

Referring to FIG. 4, the gray voltage generator 800 includes a series clock terminal SCLK for receiving a clock signal, reference voltage input terminals REFH and REFL, a ground terminal GND, a serial data input terminal SDI for receiving a serial data input signal, an enable terminal ENA for receiving an enable signal, and eight reference gray voltage output terminals OUTA, OUTB, OUTC, OUTD, OUTE, OUTF, OUTG, and OUTH.

The reference voltage input terminals REFH, REFL receive the references voltages VREFH, VREFL which are used for producing reference gray voltages along with the ground voltage GND. The reference voltages are composed of upper reference voltage VREFH having a relatively higher voltage and lower reference voltage VREFL having a relatively lower voltage.

The serial data input signal SDI is a data signal which includes information for generating a reference gray voltage and is usually supplied from signal controller 600. The serial data input signal SDI may include 3 bits, which designate the output terminal of the reference gray voltage, and 10 bits which designate the magnitude of the reference gray voltage. Also, the serial data input signal SDI may include a digital signal which controls the operation of the gray voltage generator 800.

Referring to FIG. 5 and FIG. 6, the serial data input signal SDI is activated and valid while the enable signal ENA is low. The 10^{th}, 11^{th}, and 12^{th} bit (B10, B11, and B12) of the serial data input signal SDI are identified as A0, A1, and A2 in FIG. 6. According to the data of each bit, the output terminal of the reference gray voltage is determined. For example, if A2, A1, A0 has 0, 0, 0 data, the output terminal of the reference gray voltage is designated as OUTA which is the first terminal. If A2, A1, A0 has 0, 1, 1 data, the output terminal of the reference gray voltage is designated as the third output terminal OUTC. When A2, A1, A0 equals 1, 1, 1, the eighth output terminal OUTH of the gray voltage generator is designated.

The 9^{th} to 0^{th} bits, B9-B0, of the serial data input signal SDI are identified as D9, D8, D7, D6, D5, D4, D3, D2, D1, and D0 in FIG. 6 which are binary gamma data to determine the output value of the reference gray voltage. For example, ‘0000000000’ of binary digit corresponds to a 0 decimal digit, ‘1111111111’ for 1023, ‘1000000000’ for 512, ‘1000000001’ for 513, and 0000011111 for 31.

The gray voltage generator 800 provides reference gray voltages to the corresponding output terminals OUTA, OUTB, OUTC, OUTD, OUTE, OUTF, OUTG, and OUTH after calculating the reference gray voltages based on the gamma data. The method of calculating is as follows.

Vout=V_{REFL}+{GAMMA DATA/1024}×(V_{REFH}−V_{REFL}) [Equation 2]

Wherein, VOUT is a reference gray voltage which is provided from the reference gray voltage output terminals OUTA, OUTB, OUTC, OUTD, OUTE, OUTF, OUTG, and OUTH.

Referring to FIG. 7, of all the gray levels, the middle gray levels, which for example are gray level 32 to gray level 192, play an important role for displaying, so only reference gray voltages, which are gamma 3 to gamma 7, corresponding to the middle gray levels may be compensated. In this manner, if only some of the reference gray voltages are compensated, the burden with respect to an operating speed of the gray voltage generator 800 can be reduced.

The variation of luminance in this display device in accordance with an embodiment of the present invention is explained with reference to FIG. 8 to FIG. 12.

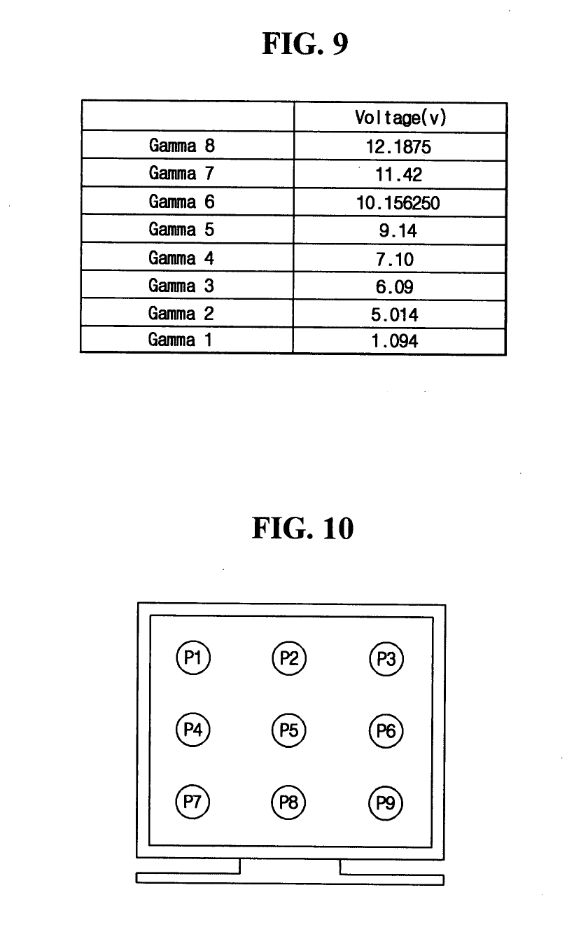

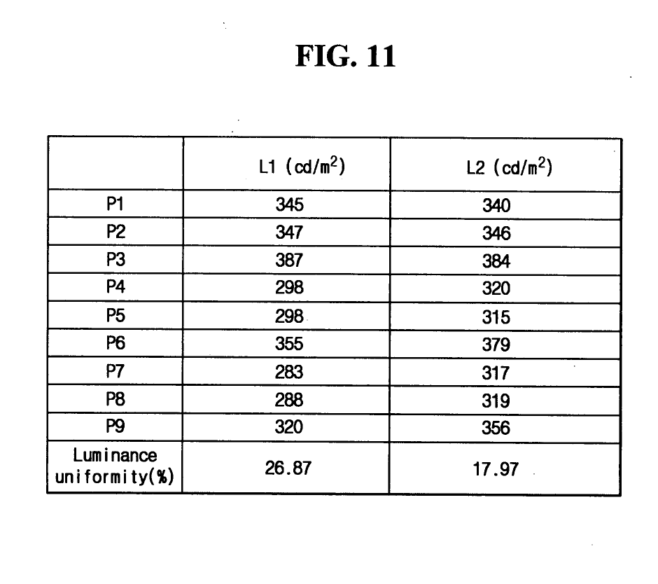

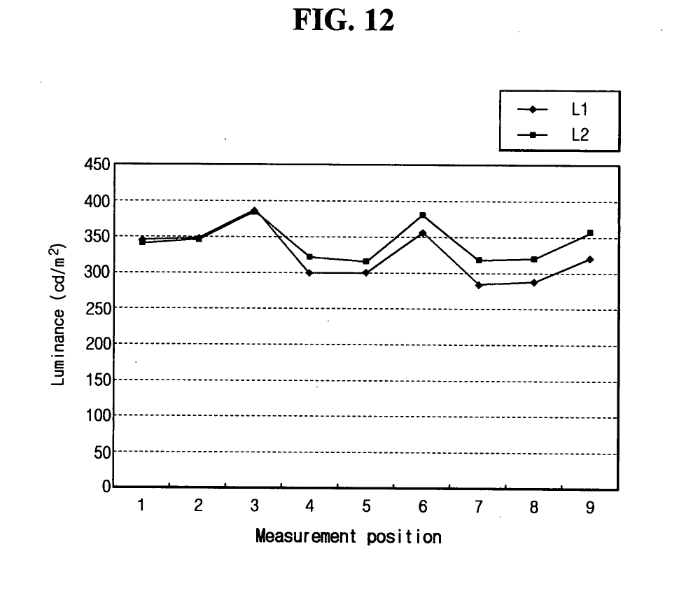

FIG. 8 and FIG. 9 are tables showing two examples of the reference gray voltages according to gamma 1 to gamma 8 in accordance with embodiments of the present invention. FIG. 10 shows one example of luminance measurement points on a display panel in accordance with an embodiment of the present invention. FIG. 11 is a table showing results obtained by measuring luminance of the positions indicated in FIG. 10 based on the examples of FIGS. 8 and 9, while FIG. 12 is a graph of FIG. 11.

Referring to FIG. 8 and FIG. 9, gamma 1, gamma 2, gamma 3, gamma 4, gamma 5, gamma 6, gamma 7, and gamma 8 are examples of the reference gray voltages for the last pixel row or row set provided through the output terminals OUTA-OUTH of the gray voltage generator 800 as shown in FIG. 4. When the voltage difference (ΔV) of the driving voltage Vdd between the first pixel row and the last pixel row, which is referred to herein as a total voltage-drop value, is 0.5V or 0.7V, reference gray voltages are shown in FIG. 8 before providing a compensation voltage while compensated reference gray voltages are shown in FIG. 9 after providing the compensation voltage based on the voltage total voltage-drop value (ΔV).

Referring to FIG. 8, gamma 1 to gamma 8, which are reference gray voltages, are fixed to 1.904 V, 5.014 V, 6.09 V, 7.10 V, 8.44 V, 9.53 V, 10.77 V and 11.64 V, respectively. On the other hand, referring to FIG. 9, gamma voltages of gamma 1 to gamma 4 have the same voltages as the gamma voltages in FIG. 8. However, the gamma voltages of gamma 5 to gamma 8 have different voltages, which are 9.14 V, 10.156250 V, 11.42 V, and 12.1875 V, respectively. Namely, the values of gamma 5 to gamma 8 of FIG. 9 have higher voltages and are greater by as much as 0.7 V, 0.62625 V, 0.65 V, and 0.5475 V, respectively, than voltages of FIG. 8. Thus, the values of gamma 5 to gamma 8 in FIG. 9 are values obtained by increasing the values of gamma 5 to gamma 8 in consideration of the total amount of voltage drop (ΔV) of the driving voltage Vdd.

After the same image data is applied to display devices having corresponding reference gray voltages as listed in FIG. 8 and FIG. 9, luminance of 9 points P1-P9 as shown in FIG. 10 were measured and the results tabulated in FIG. 11. The driving voltage Vdd was applied from the upper portion of each display panel. In FIG. 11, L1 is luminance for FIG. 8 values and L2 is luminance for FIG. 9 values.

In FIG. 10, three measurement points P1, P4, and P7 or three measurement points P3, P6, and P9 form a straight line in a column direction. As shown in FIG. 11 and FIG. 12, a display device which receives compensated reference gray voltages in accordance with an embodiment of the present invention has a lower luminance variation rate along a column than a display device which does not receive the compensated reference gray voltages.

In particular, the luminance of FIG. 9 is reduced less at P4-P9, which are at the center and bottom portions of the display panel, relative to FIG. 8.

In FIG. 11, the equation of luminance uniformity (Ln) (%) is as follows.

Ln={(Lmax−Lmin)/Lmax}×100 [Equation 3]

Herein, Lmax represents a maximum value and Lmin represents a minimum value among luminance values at the nine measurement points,

Referring to FIG. 11, when there is compensation of reference gray voltages as shown in FIG. 9, luminance uniformity is 17.97% and when there is no compensation of reference gray voltages as shown in FIG. 8, luminance uniformity is 26.87%. Therefore, it is understood that luminance uniformity is better when reference gray voltages are compensated by a compensation voltage, which is the amount of voltage drop for the driving voltage Vdd.

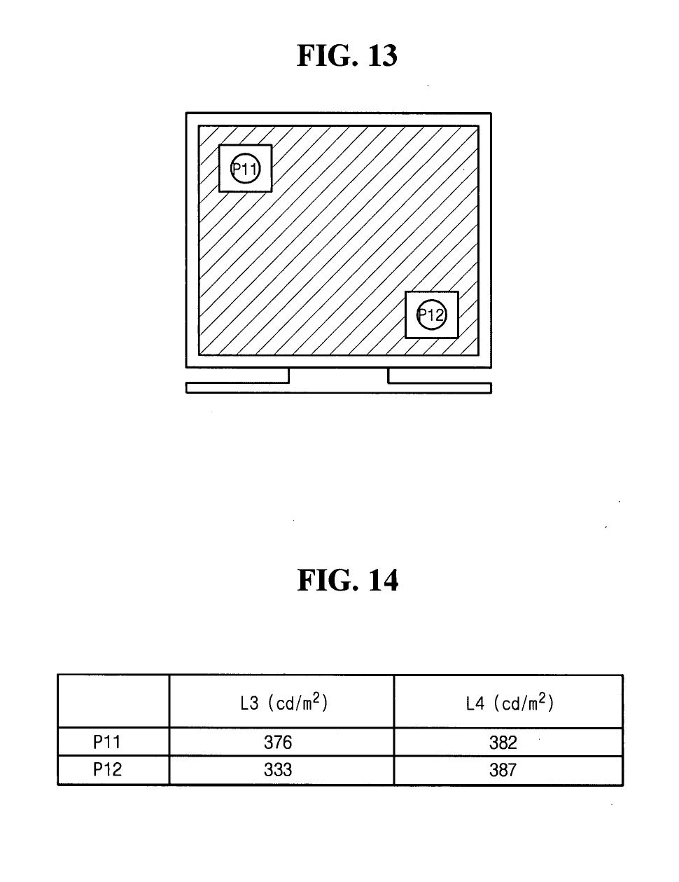

FIG. 13 and FIG. 14 are another example in accordance with an embodiment of the present invention of the effect to the display device with respect to the variation of gray levels.

For example, after applying different image data to two points P11, P12 for two different display devices having corresponding reference gray voltages of FIG. 8 and FIG. 9, luminance was measured at these two points (P11, P12) shown in FIG. 13. Driving voltage Vdd is provided from the top of the display panel. In FIG. 14, L3 shows luminance for the display device which is not compensated (FIG. 8 data), while L4 shows luminance for the display device which is compensated (FIG. 9 data).

In FIG. 13, the shaded area (with oblique lines) has a low gray level, namely black. The points of P11, P12 have a higher gray level than that of the shaded area.

Referring to FIG. 14, as shown in L3, the display device of FIG. 8, which is a display device without compensation, shows that the luminance of P11 is 376 cd/m² and the luminance of P12 is 333 cd/m². The luminance difference is 43 cd/m². In FIG. 11, the display device shows that the luminance difference between P1 and P9 is 25 cd/m². Because a gray level of a surrounding area of measurement points in FIG. 14 is higher than the measurement points in FIG. 11, FIG. 11 and FIG. 14 show measured luminance differences.

As shown in L4 in FIG. 14, the display device, which is a display device with compensation, shows that the luminance of P11 is 382 cd/m² and the luminance of P12 is 387 cd/m². The luminance difference is 5 cd/m². It shows that it is possible to preserve the uniformity of luminance even though there is a variation in gray levels according to the compensation. According to an embodiment of the present invention, the decrease of luminance at a part of the display screen may be protected by compensating for the voltage-drop without changing the driving voltage line structure and may increase the luminance uniformity.

When the gray level of the measurement positions is higher than at other portions, luminance may increase because of a high data voltage applied according to the change in the gray level than the compensation value for compensating the driving voltage Vdd, which may degrade the luminance uniformity. However, the luminance difference between the luminance at the measurement positions P11 and P12 is 5 cd/m², a level that may not degrade the luminance uniformity. Accordingly, in the display device in which the reference gray voltages are compensated according to the exemplary embodiment of the present invention, the luminance uniformity can be sustained in spite of the change in the gray level.

Accordingly, durability of display device may be extended and aperture ratio may be preserved because there is no change in the structure of the driving voltage line. According to the exemplary embodiment of the present invention, the voltage drop of a driving current can be compensated without changing the structure of the driving voltage lines, thereby preventing degradation of luminance at a portion on a screen and increasing uniformity of display. Accordingly, the elements included in the display device may be free from stress to achieve a certain luminance level, and the life span of the display device can be lengthened. In addition, because the structure of the driving voltage lines is not changed, a sufficient aperture ratio of the display device can be obtained.

Although the present invention has been described by way of exemplary embodiments, it should be understood that many changes and substitutions may further be made by those skilled in the art without departing from the scope of the present invention which is defined by the appended claims.

What is claimed is:

1. A display device comprising:
a plurality of pixels each including a switching transistor, a driving transistor, a storage capacitor, and an organic light emitting element;
a plurality of data lines coupled to the switching transistors for providing data voltages;
a plurality of driving voltage lines coupled to the driving transistors for providing driving voltages;
a gray voltage generator generating reference gray voltages which are compensated by compensation voltages; and
a data driver adapted to convert an input image signal into the data voltages based on the reference gray voltages and to provide the data voltages to the data lines.

2. The display device according to claim 1, wherein the compensation voltages are based on one or more voltage-drop values of the driving voltage.

3. The display device according to claim 2, wherein the compensation voltage varies at least every two pixel rows.

4. The display device according to claim 2, wherein the compensation voltage increases for the pixel rows farther from the data driver.

5. The display device according to claim 4, wherein a variation value of the compensation voltage is uniform.

6. The display device according to claim 4, wherein the compensation voltage of a final pixel row is approximately the same magnitude as a sum of voltage-drop values of the driving voltage along a column.

7. The display device according to claim 1, wherein the reference gray voltage varies along a pixel column.

8. The display device according to claim 1, wherein the gray voltage generator is driven in a digital manner.

9. A display device comprising:
a plurality of pixels arranged in a matrix form;
scanning lines transferring scanning signals to the pixels;
a plurality of data lines transferring a data voltage to the pixels; and
a data driver converting an input image signal with a gray level into the data voltage and applying the data voltage to the data lines,
wherein a value of a data voltage corresponding to the same gray level is different according to positions of pixels.

10. The device of claim 9, wherein the data driver selects a gray voltage corresponding to the gray level of the input image signal among a plurality of gray voltages as a data voltage and the voltage value of the gray voltage differs depending on the positions of the pixels.

11. A method for driving an OLED display device having a plurality of pixels arranged in a matrix form and a driving voltage line coupled to the pixels, the method comprising:
measuring a driving voltage difference between a first end and a second end of the driving voltage line;
generating a compensation voltage for a reference gray voltage by using the driving voltage difference;
generating a compensated reference gray voltage;
generating a gray voltage by dividing the compensated reference gray voltage; and
providing the gray voltage to the data line.

12. The method according to claim 11, wherein the compensation voltage increases along a pixel column.

13. The method according to claim 12, wherein the compensation voltage increases uniformly along the pixel column.

14. The method according to claim 12, wherein the compensation voltage varies every two pixel rows.

15. The method according to claim 11, wherein the compensation voltage of a last pixel row is substantially equal to a voltage difference between a first end and a second end of the driving voltage line.
